(19) United States
(12) Patent Application Publication
(10) Pub. No.: US 2014/0166457 A1
(43) Pub. Date: Jun. 19, 2014

(54) ILLUMINATED KEYBOARD

(71) Applicant: Primax Electronics Ltd., Taipei (TW)

(72) Inventor: Chung-Yuan Chen, Taipei (TW)

(21) Appl. No.: 13/920,993

(22) Filed: Jun. 18, 2013

(30) Foreign Application Priority Data
Dec. 19, 2012 (TW) 101148413

(51) Int. Cl. H01H 13/83

(52) U.S. Cl. CPC H01H 13/83
USPC 200/5 A

(57) ABSTRACT

An illuminated keyboard includes a key structure, a key wiring board, and a light-emitting element. The light-emitting element is located at a lateral side of the key wiring board. The key structure is disposed over the key wiring board. When the key structure is depressed, the key wiring board is triggered to generate a corresponding key signal. Moreover, a light-guiding structure is formed on the key wiring board. The light beam transferred within the key wiring board is guided by the light-guiding structure to be scattered to the key structure. After the light beam to be scattered to the key structure is converged by a light-converging microstructure on the key wiring board, the light beam is converged and centralized to be directed to keycap of the key structure.

### FIELD OF THE INVENTION

The present invention relates to a keyboard, and more particularly to an illuminated keyboard with an illuminating function.

### BACKGROUND OF THE INVENTION

A keyboard is one of the widely-used computer peripheral devices. Via the keyboard, the user may input characters or commands into a computer. Recently, with the increasing development of science and technology, the keyboard manufacturers make efforts in designing novel keyboards with diversified functions in order to meet the requirements of different users. For example, an illuminated keyboard with an illuminating function has been introduced into the market. Consequently, in case that the illuminated keyboard is used in the dim environment with insufficient luminance, the characters marked on the keys of the illuminated keyboard are still clearly visible to the user.

Hereinafter, the inner structure of the conventional illuminated keyboard will be illustrated with reference to FIG. 1. FIG. 1 is a schematic cross-sectional view illustrating a conventional illuminated keyboard.

As shown in FIG. 1, the conventional illuminated keyboard 1 comprises plural key structures 11, a membrane wiring board 12, and a light-emitting element 13.

The membrane wiring board 12 comprises a lower wiring plate 121, an upper wiring plate 122, and an intermediate plate 123. The intermediate plate 123 is arranged between the lower wiring plate 121 and the upper wiring plate 122.

The lower wiring plate 121 comprises plural lower contacts 1211. The upper wiring plate 122 comprises plural upper contacts 1221. The intermediate plate 123 has plural perforations 1231 corresponding to the plural lower contacts 1211 and the plural upper contacts 1221. Each of the upper contacts 1221 and the corresponding lower contact 1211 are collectively defined as a membrane switch 124.

Moreover, each key structure 11 comprises a keycap 111 and an elastic element 112.

For assembling the illuminated keyboard 1, the plural key structures 11 are disposed on the membrane wiring board 12, and the light-emitting element 13 is located at a side of the lower wiring plate 121 for providing a light beam to the lower wiring plate 121. The light beam is transferred within the lower wiring plate 121 along an optical path L1.

The lower wiring plate 121 is made of a light-guiding material. Moreover, plural light-guiding dots 1212 are formed on a bottom surface of the lower wiring plate 121 for collecting and scattering the light beams. The plural light-guiding dots 1212 are aligned with corresponding key structures 11. Consequently, the lower wiring plate 121 of the membrane wiring board 12 has a light-guiding function.

From the above discussions about the conventional illuminated keyboard 1, the lower wiring plate 121 of the membrane wiring board 12 is used to transfer the light beam, and the plural light-guiding dots 1212 on the bottom surface of the lower wiring plate 121 are used to scatter a portion of the light beam toward the plural key structures 11. When the portion of the light beam is directed to the plural keycaps 111, the plural key structures 11 have the luminous efficacy.

However, the conventional illuminated keyboard 1 still has some drawbacks. For example, since the membrane wiring board 12 comprises the plural lower contacts 1211 and the plural upper contacts 1221, the light-guiding dots 1212 on the lower wiring plate 121 can not be located at the positions aligned with the middle regions of the keycaps 111. In other words, the light-guiding dots 1212 can only be formed on the lower wiring plate 121 at the positions around each lower contact 1211.

After the light beam is projected onto the plural light-guiding dots 1212, a portion of the light beam that is scattered upwardly may be deviated from the plural keycaps 111. Under this circumstance, since the light beam may be leaked out through the region between every two adjacent keycaps 111, a serious light leakage problem occurs. Moreover, due to the light leakage, the intensity of the light beam outputted from the keycaps 111 will be weakened. For increasing the intensity, the light-emitting element 13 with higher luminance or more light-emitting elements 13 should be employed. Under this circumstance, the fabricating cost of the illuminated keyboard is increased.

Therefore, there is a need of providing an improved illuminated keyboard in order to eliminate the above drawbacks.

### SUMMARY OF THE INVENTION

The present invention provides an illuminated keyboard with light-converging microstructures.

In accordance with an aspect of the present invention, there is provided an illuminated keyboard. The illuminated keyboard includes at least one light-emitting element, a key wiring board, at least one key structure, at least one light-guiding structure, and at least one light-converging microstructure. The at least one light-emitting element is used for emitting at least one light beam. The key wiring board is used for generating at least one key signal and transferring the at least one light beam. The key wiring board includes an upper wiring plate, a lower wiring plate and a spacer layer. The upper wiring plate is made of a light-transmissible material. The lower wiring plate is made of a light-guiding material for transferring the at least one light beam. The spacer layer is arranged between the upper wiring plate and the lower wiring plate. The at least one key structure is disposed over the key wiring board. When the at least one key structure is depressed, the key wiring board is triggered to generate the at least one key signal. The at least one light-guiding structure is formed on the lower wiring plate and aligned with the at least one key structure. The at least one light beam from the at least one light-emitting element is guided by the at least one light-guiding structure so as to be scattered to the at least one key structure. The at least one light-converging microstructure is formed on the upper wiring plate and aligned with the at least one light-guiding structure. After the at least one light beam to be scattered to the at least one key structure is converged by the at least one light-converging microstructure, the converged light beam is directed to at least one keycap of the at least one key structure.

In accordance with another aspect of the present invention, there is provided an illuminated keyboard. The illuminated keyboard includes at least one light-emitting element, a key wiring board, at least one key structure, at least one light-guiding structure, and at least one light-converging microstructure. The at least one light-emitting element is used for emitting at least one light beam. The key wiring board is used for generating at least one key signal and transferring the at least one light beam. The key wiring board includes an upper wiring plate, a lower wiring plate and an intermediate plate. The lower wiring plate is made of a light-guiding material for transferring the at least one light beam. The intermediate plate is arranged between the upper wiring plate and the lower wiring plate for separating the upper wiring plate from the lower wiring plate. The at least one key structure is disposed over the key wiring board. When the at least one key structure is depressed, the key wiring board is triggered to generate the at least one key signal. The at least one light-guiding structure is formed on the lower wiring plate and aligned with the at least one key structure. The at least one light beam from the at least one light-emitting element is guided by the at least one light-guiding structure so as to be scattered to the at least one key structure. The at least one light-converging microstructure is formed on the upper wiring plate or the intermediate plate and aligned with the at least one light-guiding structure. After the at least one light beam to be scattered to the at least one key structure is converged by the at least one light-converging microstructure, the converged light beam is directed to at least one keycap of the at least one key structure.

In accordance with a further aspect of the present invention, there is provided an illuminated keyboard. The illuminated keyboard includes at least one light-emitting element, a key wiring board, at least one key structure, at least one light-guiding structure, and at least one light-converging microstructure. The at least one light-emitting element is used for emitting at least one light beam. The key wiring board is used for generating at least one key signal and transferring the at least one light beam. The key wiring board includes an upper wiring plate, a lower wiring plate, and an intermediate plate. The upper wiring plate is made of a light-transmissible material. The intermediate plate is made of a light-guiding material for transferring the at least one light beam. The intermediate plate is arranged between the upper wiring plate and the lower wiring plate for separating the upper wiring plate from the lower wiring plate. The at least one key structure is disposed over the key wiring board. When the at least one key structure is depressed, the key wiring board is triggered to generate the at least one key signal. The at least one light-guiding structure is formed on the intermediate plate and aligned with the at least one key structure. The at least one light beam from the at least one light-emitting element is guided by the at least one light-guiding structure so as to be scattered to the at least one key structure. The at least one light-converging microstructure is formed on the upper wiring plate and aligned with the at least one light-guiding structure. After the at least one light beam to be scattered to the at least one key structure is converged by the at least one light-converging microstructure, the converged light beam is directed to at least one keycap of the at least one key structure.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a conventional illuminated keyboard;

FIG. 2 is a schematic cross-sectional view illustrating an illuminated keyboard according to a first embodiment of the present invention;

FIG. 3 is a schematic cross-sectional view illustrating a variant of the illuminated keyboard according to the first embodiment of the present invention;

FIG. 4 is a schematic exploded view illustrating a key wiring board of the illuminated keyboard according to the first embodiment of the present invention;

FIG. 5 is a schematic cross-sectional view illustrating an illuminated keyboard according to a second embodiment of the present invention;

FIG. 6 is a schematic cross-sectional view illustrating a variant of the illuminated keyboard according to the second embodiment of the present invention;

FIG. 7 is a schematic exploded view illustrating a key wiring board of the illuminated keyboard according to the second embodiment of the present invention;

FIG. 8 is a schematic cross-sectional view illustrating an illuminated keyboard according to a third embodiment of the present invention;

FIG. 9 is a schematic cross-sectional view illustrating a variant of the illuminated keyboard according to the third embodiment of the present invention;

FIG. 10 is a schematic exploded view illustrating a key wiring board of the illuminated keyboard according to the third embodiment of the present invention;

FIG. 11 is a schematic cross-sectional view illustrating another variant of the illuminated keyboard according to the third embodiment of the present invention;

FIG. 12 is a schematic cross-sectional view illustrating a further variant of the illuminated keyboard according to the third embodiment of the present invention;

FIG. 13 is a schematic cross-sectional view illustrating an illuminated keyboard according to a fourth embodiment of the present invention;

FIG. 14 is a schematic cross-sectional view illustrating a variant of the illuminated keyboard according to the fourth embodiment of the present invention;

FIG. 15 is a schematic exploded view illustrating a key wiring board of the illuminated keyboard according to the fourth embodiment of the present invention;

FIG. 16 is a schematic cross-sectional view illustrating another variant of the illuminated keyboard according to the fourth embodiment of the present invention;

FIG. 17 is a schematic cross-sectional view illustrating a further variant of the illuminated keyboard according to the fourth embodiment of the present invention;

FIG. 18 is a schematic cross-sectional view illustrating an illuminated keyboard according to a fifth embodiment of the present invention;

FIG. 19 is a schematic cross-sectional view illustrating a variant of the illuminated keyboard according to the fifth embodiment of the present invention;

FIG. 20 is a schematic cross-sectional view illustrating an illuminated keyboard according to a sixth embodiment of the present invention; and

FIG. 21 is a schematic cross-sectional view illustrating a variant of the illuminated keyboard according to the sixth embodiment of the present invention.

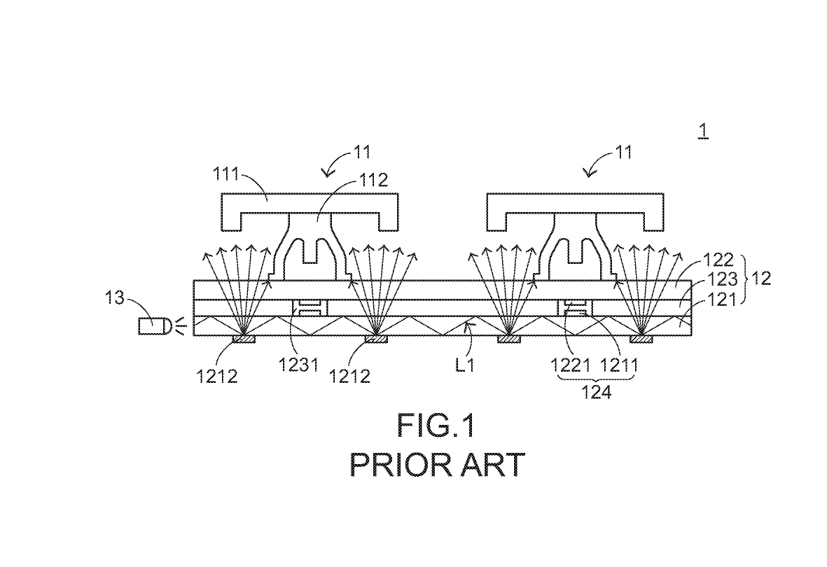

### DETAILED DESCRIPTION OF THE PREFERRED EMBODIMENT

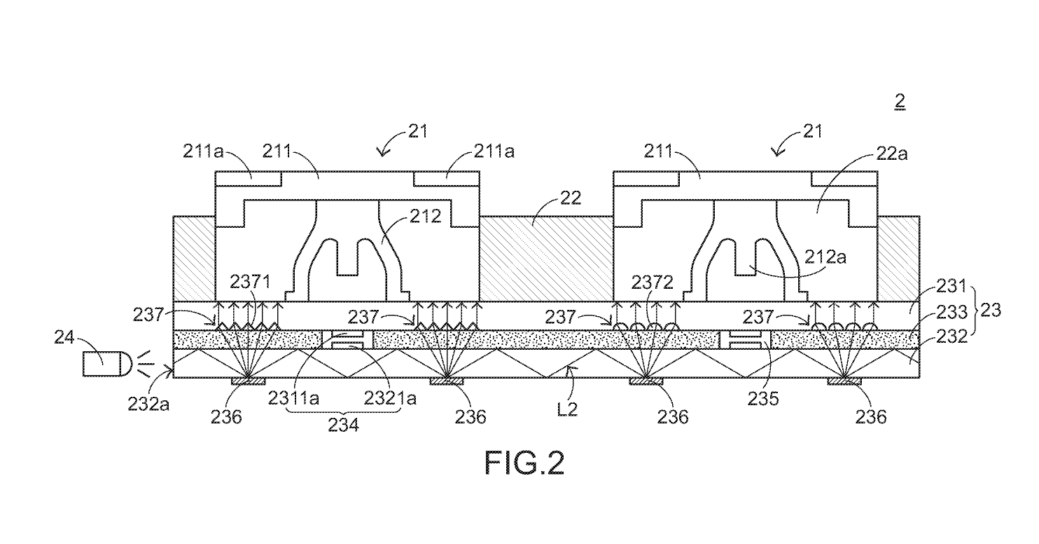

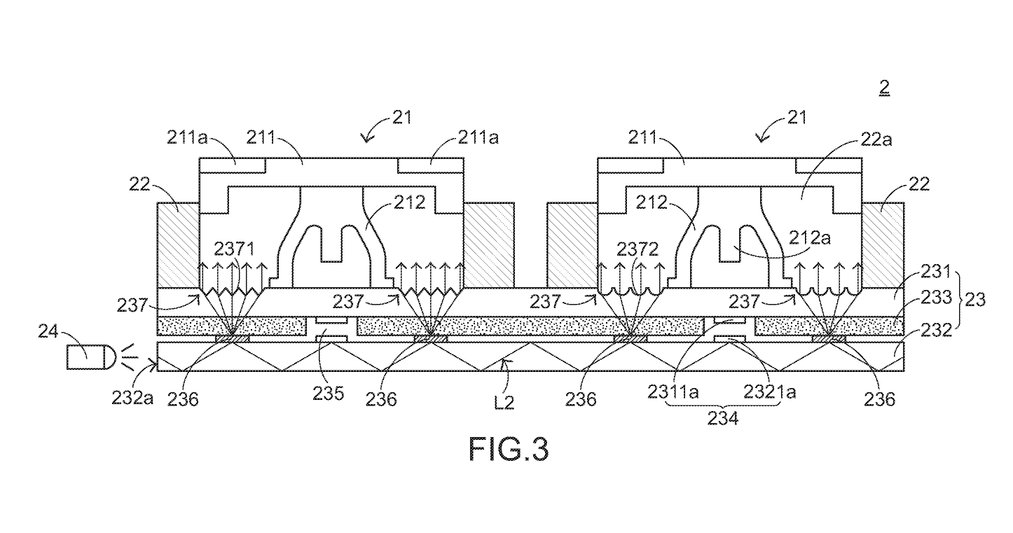

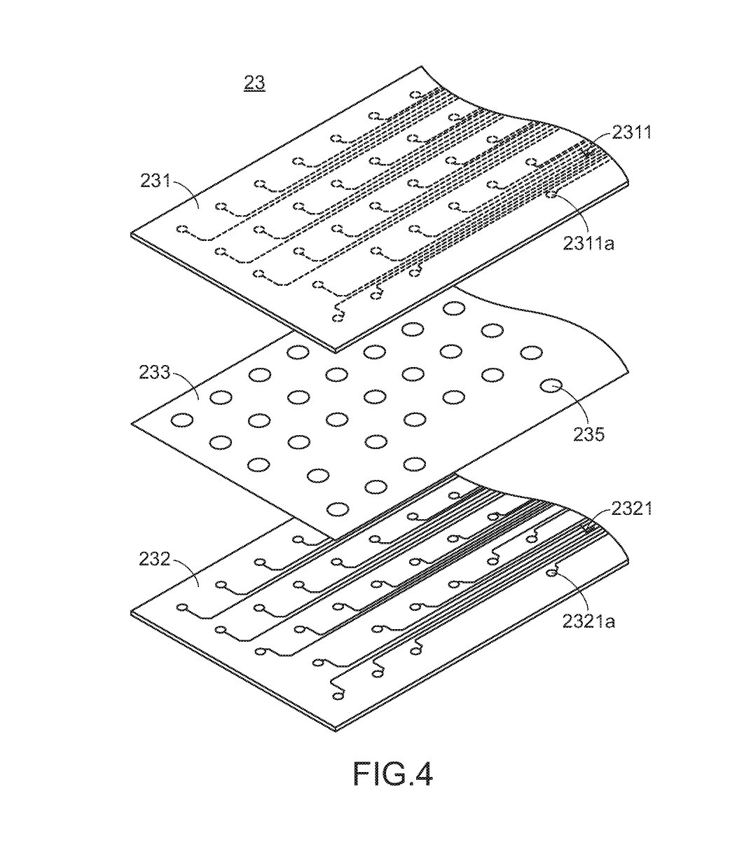

Hereinafter, the structures of an illuminated keyboard according to a first embodiment of the present invention will be illustrated with reference to FIGS. 2, 3 and 4. FIG. 2 is a schematic cross-sectional view illustrating an illuminated keyboard according to a first embodiment of the present invention. FIG. 3 is a schematic cross-sectional view illustrating a variant of the illuminated keyboard according to the first embodiment of the present invention. FIG. 4 is a schematic exploded view illustrating a key wiring board of the illuminated keyboard according to the first embodiment of the present invention.

As shown in FIGS. 2 and 3, the illuminated keyboard 2 comprises plural key structures 21, a keycap guiding frame 22, and a key wiring board 23. Moreover, at least one light-emitting element 24 is located at a side of the key wiring board 23.

The structures of the key wiring board 23 will be illustrated in more details as follows. The key wiring board 23 as shown in FIG. 4 is presented herein for purpose of illustration and description only, and is not intended to limit the forming method and the circuit pattern of the key wiring board 23.

The key wiring board 23 is disposed under the plural key structures 21 for sensing whether the key structures 21 are depressed by the user, thereby generating corresponding plural key signals. In response to the key signals, corresponding functions are executed. For example, characters, symbols or numbers may be inputted into a computer system in response to the key signals. In this embodiment, the key wiring board 23 is a membrane switch wiring board.

The key wiring board 23 comprises an upper wiring plate 231, a lower wiring plate 232, and a spacer layer 233. A first circuit pattern 2321 is formed on a top surface of the lower wiring plate 232, and the first circuit pattern 2321 comprises plural lower contacts 2321a. A second circuit pattern 2311 is formed on a bottom surface of the upper wiring plate 231, and the second circuit pattern 2311 comprises plural upper contacts 2311a corresponding to the plural lower contacts 2321a. Moreover, each of the upper contacts 2311a and the corresponding lower contact 2321a are collaboratively defined as a membrane switch 234. Each membrane switch 234 is aligned with a corresponding key structure 21.

The spacer layer 233 is formed on the top surface of the lower wiring plate 232 or the bottom surface of the upper wiring plate 231. Due to the spacer layer 233, the lower wiring plate 232 and the upper wiring plate 231 are separated from each other, and each of the plural upper contacts 2311a and the corresponding lower contact 2321a are separated from each other by a specified distance. Since the spacer layer 233 is not arranged between the plural upper contacts 2311a and the plural lower contacts 2321a, there is a vacant space 235 between each of the plural upper contacts 2311a and the corresponding lower contact 2321a. In this embodiment, the spacer layer 233 is a UV insulating ink layer.

The light-emitting element 24 is located at a lateral side 232a of the lower wiring plate 232 for providing a light beam to the lower wiring plate 232. In this embodiment, the light-emitting element 24 is a light emitting diode (LED).

It is noted that the position of the light-emitting element 24 is not restricted. The light-emitting element 24 may be located at any lateral side of the lower wiring plate 232. Alternatively, in some other embodiments, the illuminated keyboard 2 comprises two light-emitting elements 24, and the two light-emitting elements 24 are located at bilateral sides of the lower wiring plate 232, respectively.

After the light beam from the light-emitting element 24 is incident into the lower wiring plate 232, the light beam is transferred within the lower wiring plate 232 along an optical path L2. The optical path L2 is presented herein for purpose of illustration and description only, and is not intended to limit the optical path of the light beam of the present invention.

The lower wiring plate 232 has low absorptivity and high refraction coefficient. Preferably, the lower wiring plate 232 is made of a transparent light-guiding material. An example of the transparent light-guiding material includes but is not limited to polycarbonate (PC), polymethylmethacrylate (PMMA), polyethylene terephthalate (PET) or silicone.

Moreover, plural light-guiding structures 236 are formed on a bottom surface of the lower wiring plate 232 (see FIG. 2) or the top surface of the lower wiring plate 232 (see FIG. 3) for collecting and scattering the light beam, which is provided by the light-emitting element 24. The plural light-guiding structures 236 are aligned with corresponding key structures 21. When the light beam is projected on the plural light-guiding structures 236, a portion of the light beam is scattered to the plural key structures 21 by the plural light-guiding structures 236.

In this embodiment, the plural light-guiding structures 236 are produced by printing light-guiding ink on the bottom surface or the top surface of the lower wiring plate 232. The method of forming the plural light-guiding structures 236 on the bottom surface or the top surface of the lower wiring plate 232 is not restricted as long as the a portion of the light beam can be scattered to the plural key structures 21 by the plural light-guiding structures 236.

In accordance with a feature of the present invention, the illuminated keyboard 2 further comprises plural light-converging microstructures 237. The plural light-converging microstructures 237 are disposed over and aligned with the plural light-guiding structures 236, respectively. The portion of the light beam that is scattered to the plural key structures 21 by the plural light-guiding structures 236 is then transmitted through the plural light-converging microstructures 237 corresponding to the plural light-guiding structures 236. By the plural light-converging microstructures 237, the portion of the light beam that is scattered to the plural key structures 21 is converged, so that the deviated light beam can be directed to plural keycaps 211 of the plural key structures 21. Consequently, the plural keycaps 211 of the plural key structures 21 will exhibit high luminous efficacy.

Please refer to FIGS. 2 and 3 again. In this embodiment, the plural light-converging microstructures 237 may be formed on the bottom surface of the upper wiring plate 231 or the top surface of the upper wiring plate 231 and at the positions corresponding to the plural light-guiding structures 236. Moreover, the plural light-converging microstructures 237 may be produced by a laser engraving process or a chemical etching process or a hot pressing process. For example, the plural light-converging microstructures 237 include plural V-cut structures 2371 or plural U-cut structures 2372, but are not limited thereto.

The plural light-converging microstructures 237 as shown in FIGS. 2 and 3 are presented herein for purpose of illustration and description only, and are not intended to limit the shapes and distribution range of the plural light-converging microstructures 237. The plural light-converging microstructures 237 are not restricted as long as the portion of the light beam scattered to the plural key structures 21 by the plural light-guiding structures 236 can be converged and collected to be directed to the plural keycaps 211 of the plural key structures 21.

Moreover, in this embodiment, the upper wiring plate 231 is made of a light-transmissible material. Consequently, the portion of the light beam to be scattered to the plural key structures 21 by the plural light-guiding structures 236 can be transmitted through the upper wiring plate 231 and directed to the plural key structures 21.

Please refer to FIGS. 2 and 3 again. The configurations of the plural key structures 21 and the keycap guiding frame 22 of the illuminated keyboard 2 according to the first embodiment of the present invention will be illustrated in more details as follows. Firstly, each key structure 21 comprises a keycap 211 and an elastic element 212.

Each keycap 211 has plural light-outputting parts 211a. For example, the light-outputting parts 211a are located at the positions corresponding to character regions or symbol regions of the keycap 211. When the light beam is projected onto the keycap 211, the light beam can be outputted from the plural light-outputting parts 211a.

The keycap guiding frame 22 is disposed over the key wiring board 23, and comprises a hollow portion 22a. The keycap 211 is fixed in the hollow portion 22a of the keycap guiding frame 22. In addition, the keycap 211 is movable upwardly or downwardly within the hollow portion 22a.

As shown in FIG. 2, the keycap guiding frame 22 is an integral sheet-like body. That is, the keycap guiding frame 22 is shared by the plural keycaps 211. Moreover, the keycap guiding frame 22 has plural hollow portions 22a under the plural keycaps 211 for accommodating the plural keycaps 211, respectively. Alternatively, in the variant example of FIG. 3, the illuminated keyboard 2 comprises plural independent keycap guiding frames 22. Each keycap guiding frame 22 is disposed under a corresponding keycap 211. Moreover, each keycap guiding frame 22 has a corresponding hollow portion 22a for accommodating the corresponding keycap 211.

Next, the elastic element 212 is disposed under the keycap 211. Moreover, the elastic element 212 has a protrusion part 212a. The protrusion part 212a is disposed within the elastic element 212.

As any keycap 211 is depressed, the keycap 211 is moved downwardly to compress the elastic element 212, and thus the elastic element 212 is subjected to deformation. Consequently, the protrusion part 212a is moved downwardly to depress the upper wiring plate 231. As the upper wiring plate 231 is depressed, the upper contact 2311a corresponding to the keycap 211 is inserted into the corresponding vacant space 235 and thus contacted with the corresponding lower contact 2321a of the lower wiring plate 232. Under this circumstance, the membrane switch 234 is electrically conducted, and thus the illuminated keyboard 2 generates the corresponding key signal.

When the depressing force exerted on the keycap 211 is eliminated, the elastic element 212 is restored to its original shape and provides a restoring force to the keycap 211. In response to the restoring force, the keycap 211 is moved upwardly relative to the hollow portion 22a of the keycap guiding frame 22 and thus returned to its original position where the keycap 211 is not depressed.

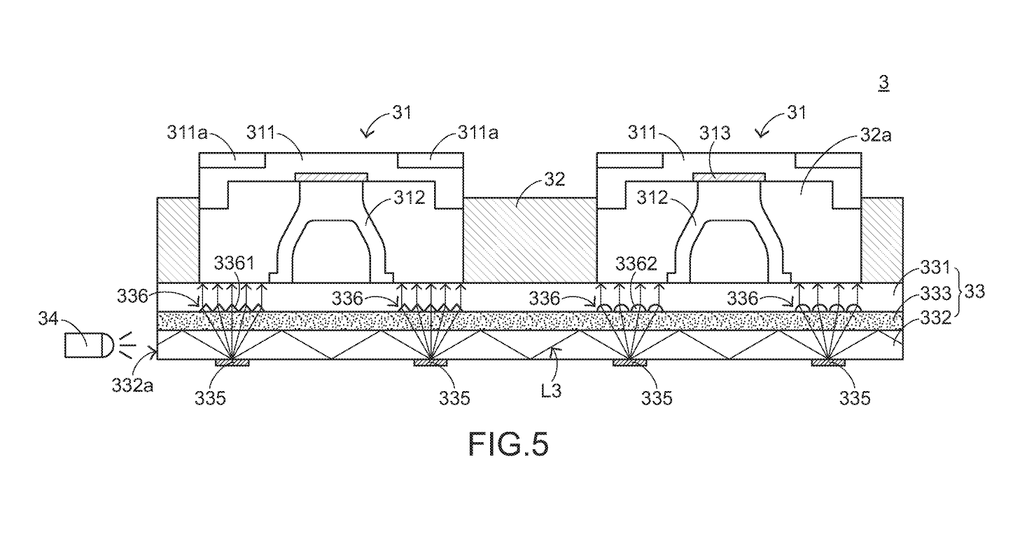

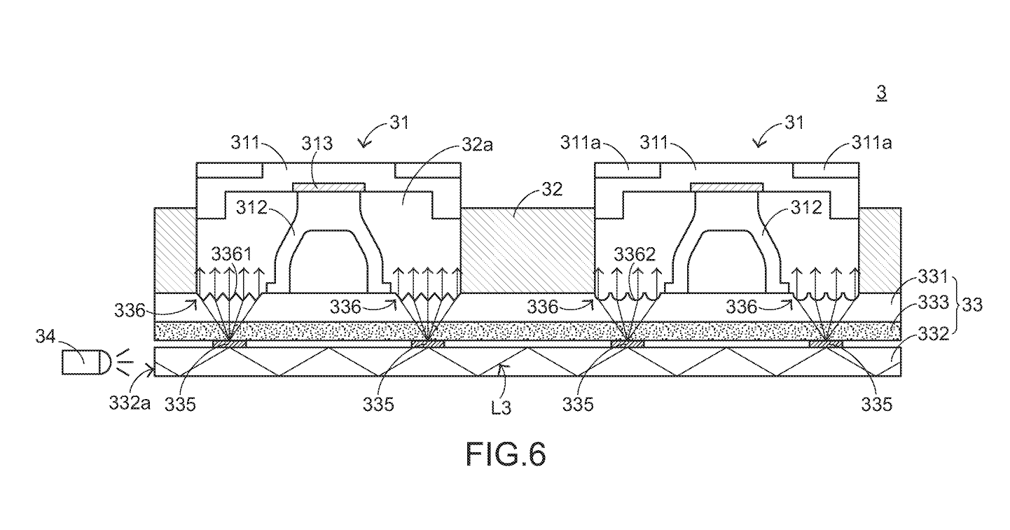

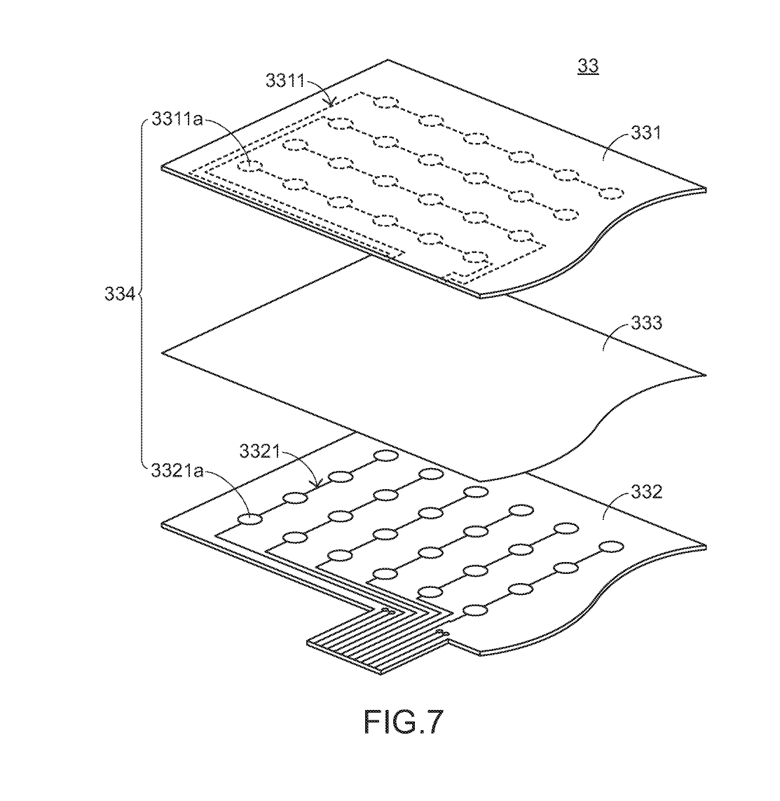

Hereinafter, the structures of an illuminated keyboard according to a second embodiment of the present invention will be illustrated with reference to FIGS. 5, 6 and 7. FIG. 5 is a schematic cross-sectional view illustrating an illuminated keyboard according to a second embodiment of the present invention. FIG. 6 is a schematic cross-sectional view illustrating a variant of the illuminated keyboard according to the second embodiment of the present invention. FIG. 7 is a schematic exploded view illustrating a key wiring board of the illuminated keyboard according to the second embodiment of the present invention.

The illuminated keyboard 3 comprises plural key structures 31, a keycap guiding frame 32, and a key wiring board 33. Moreover, at least one light-emitting element 34 is located at a side of the key wiring board 33.

In comparison with the illuminated keyboard of the first embodiment, the key wiring board 33 of this embodiment is distinguished. In this embodiment, the key wiring board 33 is a capacitive sensing wiring board.

The key wiring board 33 as shown in FIG. 7 is presented herein for purpose of illustration and description only, and is not intended to limit the forming method and the circuit pattern of the key wiring board 33.

In this embodiment, the key wiring board 33 comprises an upper wiring plate 331, a lower wiring plate 332, and a spacer layer 333. Moreover, a second electrode layer 3321 is formed on a top surface of the lower wiring plate 332, wherein the second electrode layer 3321 comprises plural second electrode patterns 3321a. A first electrode layer 3311 is formed on a bottom surface of the upper wiring plate 331, wherein the first electrode layer 3311 comprises first electrode patterns 3311a corresponding to the plural second electrode patterns 3321a. Each of the plural first electrode patterns 3311a and the corresponding second electrode pattern 3321a are collaboratively defined as a non-contact key switch 334. Each non-contact key switch 334 is aligned with the corresponding key structure 31.

The spacer layer 333 is formed on the top surface of the lower wiring plate 332 or the bottom surface of the upper wiring plate 331. Due to the spacer layer 333, the lower wiring plate 332 and the upper wiring plate 331 are separated from each other, and the first electrode layer 3311 and the second electrode layer 3321 are separated from each other by a specified distance. In this embodiment, the spacer layer 333 is a UV insulating ink layer.

As shown in FIGS. 5 and 6, the light-emitting element 34 is located at a lateral side 332a of the lower wiring plate 332 for providing a light beam to the lower wiring plate 332. In this embodiment, the light-emitting element 34 is a light emitting diode (LED).

It is noted that the position of the light-emitting element 34 is not restricted. The light-emitting element 34 may be located at any lateral side of the lower wiring plate 332. Alternatively, in some other embodiments, the illuminated keyboard 3 comprises two light-emitting elements 34, and the two light-emitting elements 34 are located at bilateral sides of the lower wiring plate 332, respectively.

After the light beam from the light-emitting element 34 is incident into the lower wiring plate 332, the light beam is transferred within the lower wiring plate 332 along an optical path L3. The optical path L3 is presented herein for purpose of illustration and description only, and is not intended to limit the optical path of the light beam of the present invention.

The lower wiring plate 332 has low absorptivity and high refraction coefficient. Preferably, the lower wiring plate 332 is made of a transparent light-guiding material. An example of the transparent light-guiding material includes but is not limited to polycarbonate (PC), polymethylmethacrylate (PMMA), polyethylene terephthalate (PET) or silicone.

Moreover, plural light-guiding structures 335 are formed on a bottom surface of the lower wiring plate 332 (see FIG. 5) or the top surface of the lower wiring plate 332 (see FIG. 6) for collecting and scattering the light beam, which is provided by the light-emitting element 34. The plural light-guiding structures 335 are aligned with corresponding key structures 31. When the light beam is projected on the plural light-guiding structures 335, a portion of the light beam is scattered to the plural key structures 31 by the plural light-guiding structures 335.

In this embodiment, the plural light-guiding structures 335 are produced by printing light-guiding ink on the bottom surface or the top surface of the lower wiring plate 332. The method of forming the plural light-guiding structures 335 on the bottom surface or the top surface of the lower wiring plate 332 is not restricted as long as the a portion of the light beam can be scattered to the plural key structures 31 by the plural light-guiding structures 335.

In accordance with a feature of the present invention, the illuminated keyboard 3 further comprises plural light-converging microstructures 336. The plural light-converging microstructures 336 are disposed over and aligned with the plural light-guiding structures 335, respectively. The portion of the light beam that is scattered to the plural key structures 31 by the plural light-guiding structures 335 is then transmitted through the plural light-converging microstructures 336 corresponding to the plural light-guiding structures 335. By the plural light-converging microstructures 336, the portion of the light beam that is scattered to the plural key structures 31 is converged, so that the deviated light beam can be directed to plural keycaps 311 of the plural key structures 31. Consequently, the plural keycaps 311 of the plural key structures 31 will exhibit high luminous efficacy.

Please refer to FIGS. 5 and 6 again. In this embodiment, the plural light-converging microstructures 336 may be formed on the bottom surface of the upper wiring plate 331 or the top surface of the upper wiring plate 331 and at the positions corresponding to the plural light-guiding structures 335. Moreover, the plural light-converging microstructures 336 may be produced by a laser engraving process or a chemical etching process or a hot pressing process. For example, the plural light-converging microstructures 336 include plural V-cut structures 3361 or plural U-cut structures 3362, but are not limited thereto.

The plural light-converging microstructures 336 as shown in FIGS. 5 and 6 are presented herein for purpose of illustration and description only, and are not intended to limit the shapes and distribution range of the plural light-converging microstructures 336. The plural light-converging microstructures 336 are not restricted as long as the portion of the light beam scattered to the plural key structures 31 by the plural light-guiding structures 335 can be converged and collected to be directed to the plural keycaps 311 of the plural key structures 31.

For allowing the light beam from the light-emitting element 34 to be projected onto the plural key structures 31, the upper wiring plate 331 is made of a transparent material. Consequently, the light beam can be transmitted through the upper wiring plate 331. In this embodiment, the first electrode layer 3331 and the second electrode layer 3321 are made of a transparent conductive material. An example of the transparent conductive material includes but is not limited to indium tin oxide (ITO), indium zinc oxide, aluminum zinc oxide, conductive polymeric material, graphene, silver bromide (AgBr), indium gallium zinc oxide (IGZO), carbon nanotube, nano silver or nano copper.

Please refer to FIGS. 5 and 6 again. The configurations of the plural key structures 31 and the keycap guiding frame 32 of the illuminated keyboard 3 according to the second embodiment of the present invention will be illustrated in more details as follows. Firstly, each key structure 31 comprises a keycap 311 and an elastic element 312.

Each keycap 311 has plural light-outputting parts 311a. For example, the light-outputting parts 311a are located at the positions corresponding to character regions or symbol regions of the keycap 311. When the light beam is projected onto the keycap 311, the light beam can be outputted from the plural light-outputting parts 311a.

The keycap guiding frame 32 is disposed over the key wiring board 33, and comprises a hollow portion 32a. The keycap 311 is fixed in the hollow portion 32a of the keycap guiding frame 32. In addition, the keycap 311 is movable upwardly or downwardly within the hollow portion 32a. Moreover, the elastic element 312 is disposed under the keycap 311.

When the key wiring board 33 is electrically conducted, an electric field between each of the first electrode patterns 3311a and the corresponding second electrode pattern 3321a of the non-contact key switch 334 are generated. As any keycap 311 is depressed, the keycap 311 is moved downwardly to compress the elastic element 312, and thus the elastic element 312 is subjected to deformation. When the keycap 311 and the elastic element 312 are moved to a position near the non-contact key switch 334, the electric field generated by the non-contact key switch 334 is changed. Due to the change of the electric field, a controller (not shown) generates a corresponding non-contact key signal.

When the depressing force exerted on the keycap 311 is eliminated, the elastic element 312 is restored to its original shape. In addition, the keycap 311 is returned to its original position where the keycap 311 is not depressed.

For resulting in the change of the electric field of the non-contact key switch 334 corresponding to the depressed key structure 31, the key structure 31 further comprises a conductive structure 313 (see FIGS. 5 and 6). When the conductive structure 313 is moved to a position near the non-contact key switch 334, the electric field generated by the non-contact key switch 334 is changed. For example, the conductive structure 313 is metallic paint film coated on the key structure 31 or a conductive foam structure fixed on the key structure 31, but is not limited thereto.

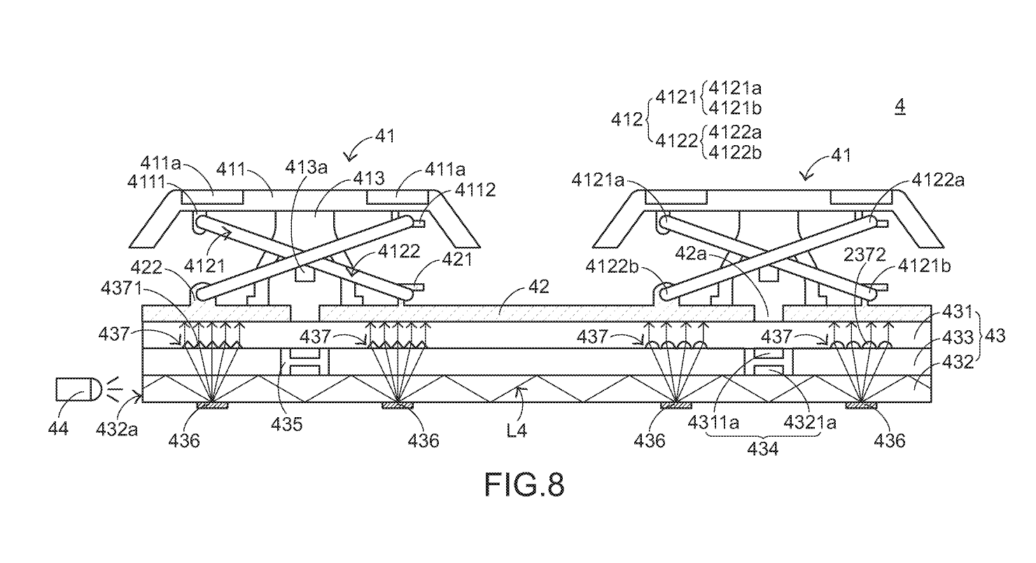

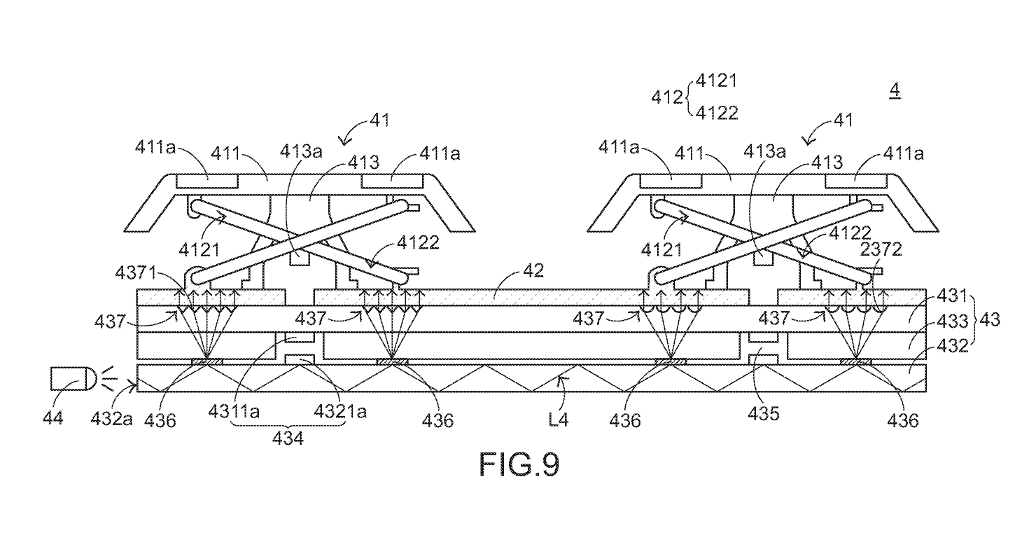

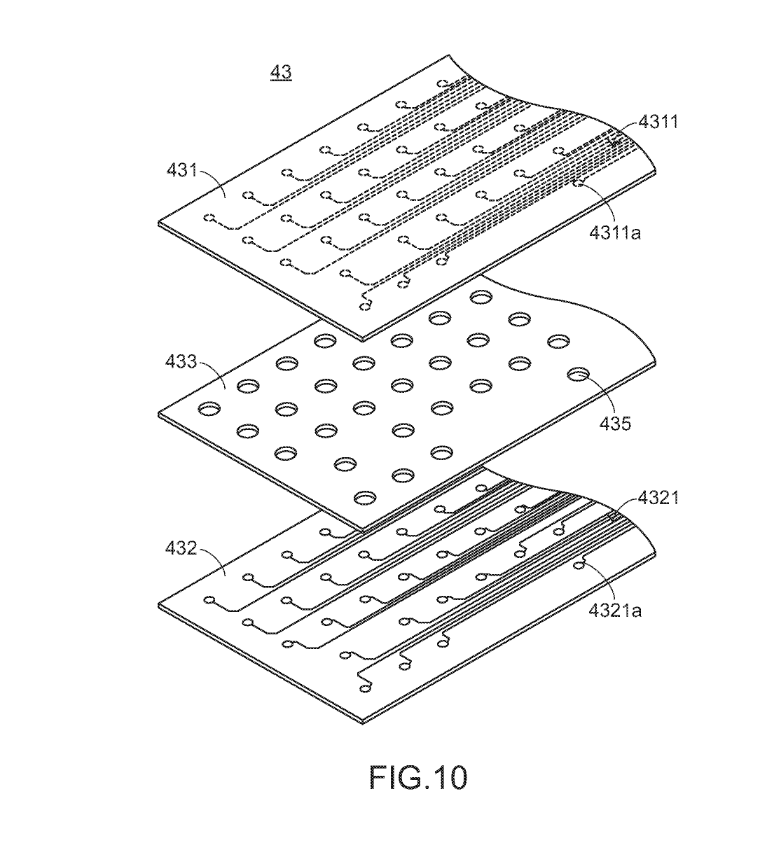

Hereinafter, the structures of an illuminated keyboard according to a third embodiment of the present invention will be illustrated with reference to FIGS. 8, 9 and 10. FIG. 8 is a schematic cross-sectional view illustrating an illuminated keyboard according to a third embodiment of the present invention. FIG. 9 is a schematic cross-sectional view illustrating a variant of the illuminated keyboard according to the third embodiment of the present invention. FIG. 10 is a schematic exploded view illustrating a key wiring board of the illuminated keyboard according to the third embodiment of the present invention.

As shown in FIGS. 8 and 9, the illuminated keyboard 4 comprises plural key structures 41, a supporting plate 42, and a key wiring board 43. Moreover, at least one light-emitting element 44 is located at a side of the key wiring board 43.

The structures of the key wiring board 43 will be illustrated in more details as follows. In this embodiment, the key wiring board 43 is a membrane switch wiring board. The key wiring board 43 as shown in FIG. 10 is presented herein for purpose of illustration and description only, and is not intended to limit the forming method and the circuit pattern of the key wiring board 43.

The key wiring board 43 is disposed under the plural key structures 41. In this embodiment, the key wiring board 43 comprises an upper wiring plate 431, a lower wiring plate 432, and an intermediate plate 433. In comparison with the first embodiment, the key wiring board 43 comprises the intermediate plate 433.

In particular, a first circuit pattern 4321 is formed on a top surface of the lower wiring plate 432, and the first circuit pattern 4321 comprises plural lower contacts 4321a. A second circuit pattern 4311 is formed on a bottom surface of the upper wiring plate 431, and the second circuit pattern 4311 comprises plural upper contacts 4311a corresponding to the plural lower contacts 4321a. Moreover, each of the upper contacts 4311a and the corresponding lower contact 4321a are collaboratively defined as a membrane switch 434. Each membrane switch 434 is aligned with a corresponding key structure 41.

The intermediate plate 433 is arranged between the lower wiring plate 432 and the upper wiring plate 431. Due to the intermediate plate 433, the lower wiring plate 432 and the upper wiring plate 431 are separated from each other, and each of the plural upper contacts 4311a and the corresponding lower contact 4321a are separated from each other by a specified distance. Moreover, the intermediate plate 433 has plural perforations 435 corresponding to the plural upper contacts 4311a.

The light-emitting element 44 is located at a lateral side 432a of the lower wiring plate 432 for providing a light beam to the lower wiring plate 432. In this embodiment, the light-emitting element 44 is a light emitting diode (LED).

It is noted that the position of the light-emitting element 44 is not restricted. The light-emitting element 44 may be located at any lateral side of the lower wiring plate 432. Alternatively, in some other embodiments, the illuminated keyboard 4 comprises two light-emitting elements 44, and the two light-emitting elements 44 are located at bilateral sides of the lower wiring plate 432, respectively.

After the light beam from the light-emitting element 44 is incident into the lower wiring plate 432, the light beam is transferred within the lower wiring plate 432 along an optical path L4. The optical path L4 is presented herein for purpose of illustration and description only, and is not intended to limit the optical path of the light beam of the present invention.

The lower wiring plate 432 has low absorptivity and high refraction coefficient. Preferably, the lower wiring plate 432 is made of a transparent light-guiding material. An example of the transparent light-guiding material includes but is not limited to polycarbonate (PC), polymethylmethacrylate (PMMA), polyethylene terephthalate (PET) or silicone.

Moreover, plural light-guiding structures 436 are formed on a bottom surface of the lower wiring plate 432 (see FIG. 8) or the top surface of the lower wiring plate 432 (see FIG. 9) for collecting and scattering the light beam, which is provided by the light-emitting element 44. The plural light-guiding structures 435 are aligned with corresponding key structures 41. When the light beam is projected on the plural light-guiding structures 436, a portion of the light beam is scattered to the plural key structures 41 by the plural light-guiding structures 436.

In this embodiment, the plural light-guiding structures 436 are produced by printing light-guiding ink on the bottom surface or the top surface of the lower wiring plate 432. The method of forming the plural light-guiding structures 436 on the bottom surface or the top surface of the lower wiring plate 432 is not restricted as long as the a portion of the light beam can be scattered to the plural key structures 41 by the plural light-guiding structures 436.

In accordance with a feature of the present invention, the illuminated keyboard 4 further comprises plural light-converging microstructures 437. The plural light-converging microstructures 437 are disposed over and aligned with the plural light-guiding structures 436, respectively. The portion of the light beam that is scattered to the plural key structures 41 by the plural light-guiding structures 436 is then transmitted through the plural light-converging microstructures 437 corresponding to the plural light-guiding structures 436. By the plural light-converging microstructures 437, the portion of the light beam that is scattered to the plural key structures 41 is converged, so that the deviated light beam can be directed to plural keycaps 411 of the plural key structures 41. Consequently, the plural keycaps 411 of the plural key structures 41 will exhibit high luminous efficacy.

Please refer to FIGS. 8 and 9. In this embodiment, the plural light-converging microstructures 437 may be formed on the bottom surface of the upper wiring plate 431 or the top surface of the upper wiring plate 431 and at the positions corresponding to the plural light-guiding structures 436. Moreover, the plural light-converging microstructures 437 may be produced by a laser engraving process or a chemical etching process or a hot pressing process. For example, the plural light-converging microstructures 437 include plural V-cut structures 4371 or plural U-cut structures 4372, but are not limited thereto.

The plural light-converging microstructures 437 as shown in FIGS. 8 and 9 are presented herein for purpose of illustration and description only, and are not intended to limit the shapes and distribution range of the plural light-converging microstructures 437. The plural light-converging microstructures 437 are not restricted as long as the portion of the light beam scattered to the plural key structures 41 by the plural light-guiding structures 436 can be converged and collected to be directed to the plural keycaps 411 of the plural key structures 41.

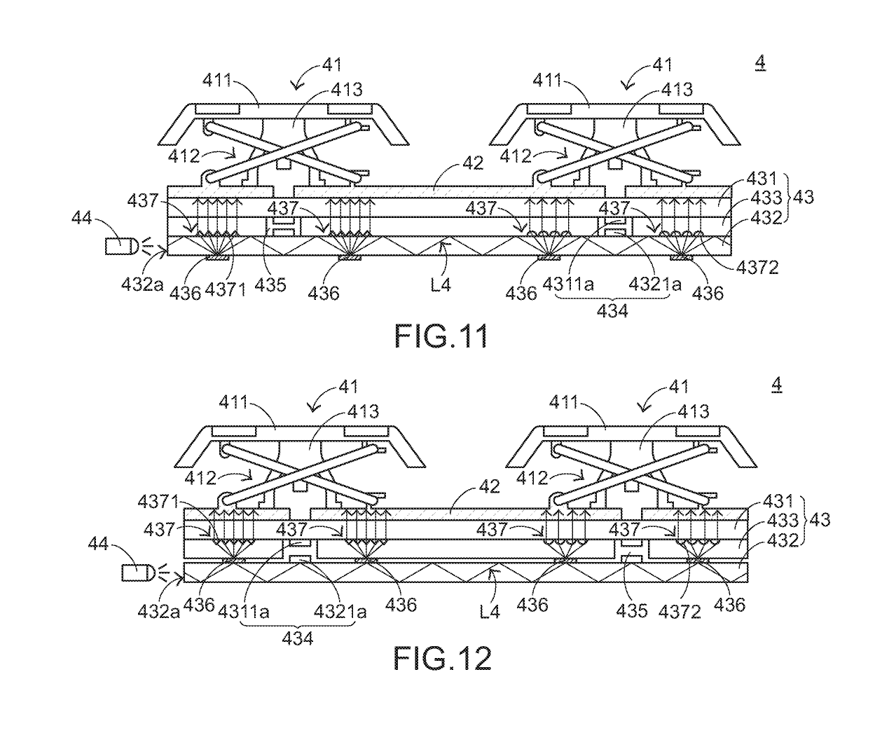

FIG. 11 is a schematic cross-sectional view illustrating another variant of the illuminated keyboard according to the third embodiment of the present invention. FIG. 12 is a schematic cross-sectional view illustrating a further variant of the illuminated keyboard according to the third embodiment of the present invention.

As shown in FIGS. 11 and 12, the plural light-converging microstructures 437 may be formed on a bottom surface of the intermediate plate 433 or a top surface of the intermediate plate 433 and at the positions corresponding to the plural light-guiding structures 436. Moreover, the plural light-converging microstructures 437 include plural V-cut structures 4371 or plural U-cut structures 4372, but are not limited thereto.

The plural light-converging microstructures 437 as shown in FIGS. 11 and 12 are presented herein for purpose of illustration and description only, and are not intended to limit the shapes and distribution range of the plural light-converging microstructures 437. The plural light-converging microstructures 437 are not restricted as long as the portion of the light beam scattered to the plural key structures 41 by the plural light-guiding structures 436 can be converged and collected to be directed to the plural keycaps 411 of the plural key structures 41.

Moreover, in this embodiment, both of the intermediate plate 433 and the upper wiring plate 431 are made of a light-transmissible material. Consequently, the portion of the light beam to be scattered to the plural key structures 41 by the plural light-guiding structures 436 can be transmitted through the intermediate plate 433 or the upper wiring plate 431 and directed to the plural key structures 41.

Please refer to FIGS. 8 and 9 again. The configurations of the plural key structures 41 and the supporting plate 42 of the illuminated keyboard 4 according to the third embodiment of the present invention will be illustrated in more details as follows.

The plural key structures 41 are disposed over the key wiring board 43. Each key structure 41 comprises a keycap 411, a scissors-type connecting element 412, and an elastic element 413.

Each keycap 411 has plural light-outputting parts 411a. For example, the light-outputting parts 411a are located at the positions corresponding to character regions or symbol regions of the keycap 411. When the light beam is projected onto the keycap 411, the light beam can be outputted from the plural light-outputting parts 411a.

Moreover, the supporting plate 42 is arranged between the supporting plate 43 and the plural key structures 41 for fixing the scissors-type connecting element 412. The elastic element 413 is arranged between the keycap 411 and the supporting plate 42 for providing a restoring force to the keycap 411.

Moreover, the scissors-type connecting element 412 comprises a first frame 4121 and a second frame 4122. The first frame 4121 is pivotally coupled to the second frame 4122, and the first frame 4121 and the second frame 4122 intersect each other. A first end 4121a of the first frame 4121 and a first end 4122a of the second frame 4122 are connected to a first fixing structure 4111 and a second fixing structure 4112 of the keycap 411, respectively. A second end 4121b of the first frame 4121 and a second end 4122b of the second frame 4122 are connected to a third fixing structure 421 and a fourth fixing structure 422 of the supporting plate 42, respectively.

In case that the supporting plate 42 is made of a light-transmissible material, it is not necessary to form openings in the supporting plate 42 at the positions corresponding to the light-outputting parts 411a. Whereas, in case that the supporting plate 42 is made of an opaque material, the supporting plate 42 should have openings under the light-outputting parts 411a. Consequently, the light beam can be transmitted through the openings, and directed to the keycaps 411.

As any keycap 411 is depressed, the first frame 4121 and the second frame 4122 are rotated relative to each other. Consequently, the keycap 411 is moved downwardly.

Then, the keycap 411 is moved downwardly to compress the elastic element 413, and thus the elastic element 413 is subjected to deformation. Consequently, a protrusion part 413a within the elastic element 413 is moved downwardly and penetrated through a corresponding opening 42a of the supporting plate 42 to depress the upper wiring plate 431. As the upper wiring plate 431 is depressed, the upper contact 4311a corresponding to the keycap 411 is inserted into the corresponding perforation 435 and thus contacted with the corresponding lower contact 4321a of the lower wiring plate 432. Under this circumstance, the membrane switch 434 is electrically conducted, and thus the illuminated keyboard 4 generates the corresponding key signal.

When the depressing force exerted on the keycap 411 is eliminated, the elastic element 413 is restored to its original shape. Consequently, the keycap 411 is moved upwardly and returned to the original position where the keycap 411 is not depressed. At the same time, the first frame 4121 and the second frame 4122 are rotated relative to each other again, and thus the first frame 4121 and the second frame 4122 are returned to their original positions.

It is noted that numerous modifications and alterations may be made while retaining the teachings of the invention. For example, the plural key structures 41 and the supporting plate 42 used in the illuminated keyboard 4 of this embodiment may be applied to the illuminated keyboard 2 of the first embodiment in order to replace the plural key structures 21 and the keycap guiding frame 22. Alternatively, the plural key structures 21 and the keycap guiding frame 22 used in the illuminated keyboard 2 of the first embodiment may be applied to the illuminated keyboard 4 of this embodiment in order to replace the plural key structures 41 and the supporting plate 42.

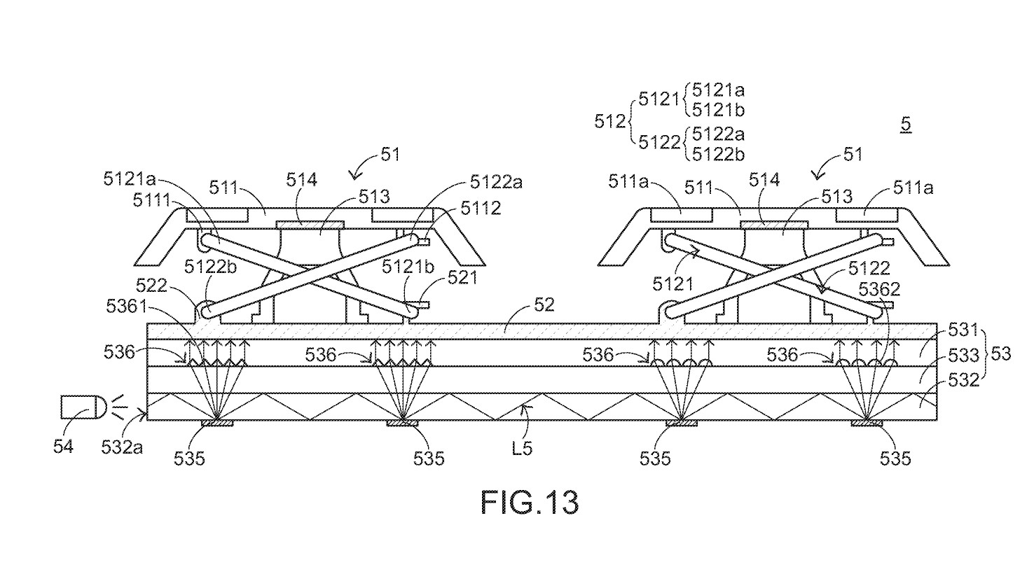

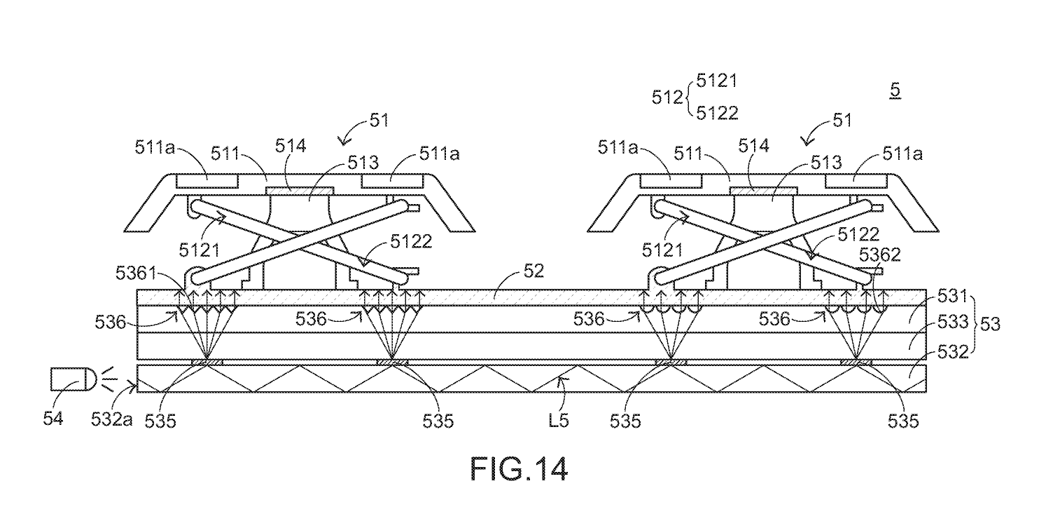

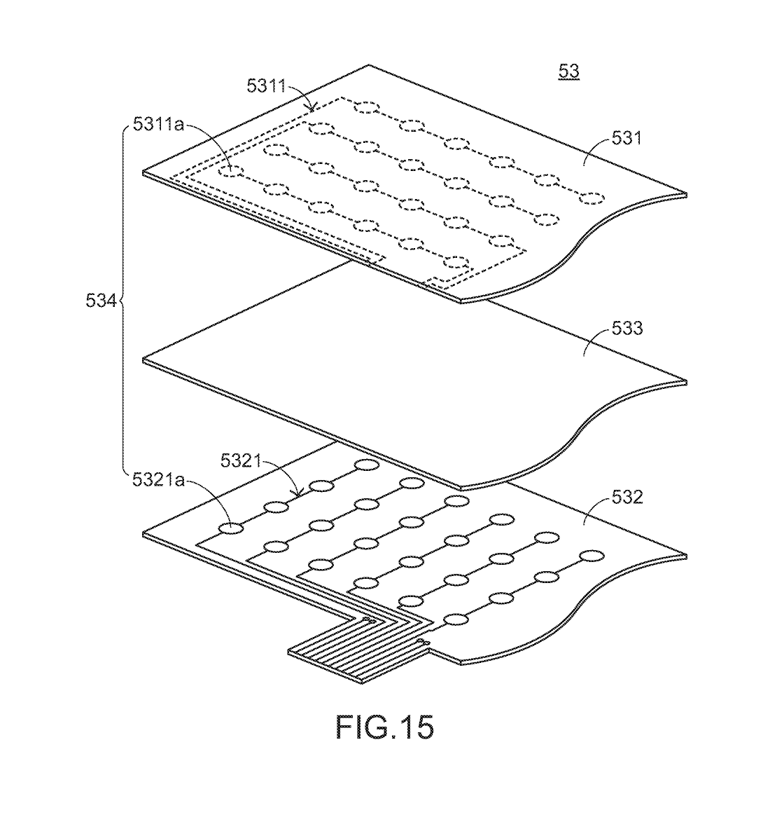

Hereinafter, the structures of an illuminated keyboard according to a fourth embodiment of the present invention will be illustrated with reference to FIGS. 13, 14 and 15. FIG. 13 is a schematic cross-sectional view illustrating an illuminated keyboard according to a fourth embodiment of the present invention. FIG. 14 is a schematic cross-sectional view illustrating a variant of the illuminated keyboard according to the fourth embodiment of the present invention. FIG. 15 is a schematic exploded view illustrating a membrane wiring board of the illuminated keyboard according to the fourth embodiment of the present invention.

As shown in FIGS. 13 and 14, the illuminated keyboard 5 comprises plural key structures 51, a supporting plate 52, and a key wiring board 53. Moreover, at least one light-emitting element 54 is located at a side of the key wiring board 53.

In comparison with the illuminated keyboard of the third embodiment, the key wiring board 53 of this embodiment is distinguished. In this embodiment, the key wiring board 53 is a capacitive sensing wiring board. The key wiring boar board 53 as shown in FIG. 15 is presented herein for purpose of illustration and description only, and is not intended to limit the forming method and the circuit pattern of the key wiring board 53.

The key wiring board 53 is disposed under the plural key structures 51. In this embodiment, the key wiring board 53 comprises an upper wiring plate 531, a lower wiring plate 532, and an intermediate plate 533. Moreover, a second electrode layer 5321 is formed on a top surface of the lower wiring plate 532, wherein the second electrode layer 5321 comprises plural second electrode patterns 5321a. A first electrode layer 5311 is formed on a bottom surface of the upper wiring plate 531, wherein the first electrode layer 5311 comprises first electrode patterns 5311a corresponding to the plural second electrode patterns 5321a. Each of the plural first electrode patterns 5311a and the corresponding second electrode pattern 5321a are collaboratively defined as a non-contact key switch 534. Each non-contact key switch 534 is aligned with the corresponding key structure 51.

The intermediate plate 533 is arranged between the lower wiring plate 532 and the upper wiring plate 531. Due to the intermediate plate 533, the lower wiring plate 532 and the upper wiring plate 531 are separated from each other, and the first electrode layer 5311 and the second electrode layer 5321 are separated from each other by a specified distance

The light-emitting element 54 is located at a lateral side 532a of the lower wiring plate 532 for providing a light beam to the lower wiring plate 532. In this embodiment, the light-emitting element 54 is a light emitting diode (LED).

It is noted that the position of the light-emitting element 54 is not restricted. The light-emitting element 54 may be located at any lateral side of the lower wiring plate 532. Alternatively, in some other embodiments, the illuminated keyboard 5 comprises two light-emitting elements 54, and the two light-emitting elements 54 are located at bilateral sides of the lower wiring plate 532, respectively.

After the light beam from the light-emitting element 54 is incident into the lower wiring plate 532, the light beam is transferred within the lower wiring plate 532 along an optical path L5. The optical path L5 is presented herein for purpose of illustration and description only, and is not intended to limit the optical path of the light beam of the present invention.

The lower wiring plate 532 has low absorptivity and high refraction coefficient. Preferably, the lower wiring plate 532 is made of a transparent light-guiding material. An example of the transparent light-guiding material includes but is not limited to polycarbonate (PC), polymethylmethacrylate (PMMA), polyethylene terephthalate (PET) or silicone.

Moreover, plural light-guiding structures 535 are formed on a bottom surface of the lower wiring plate 532 (see FIG. 13) or the top surface of the lower wiring plate 532 (see FIG. 14) for collecting and scattering the light beam, which is provided by the light-emitting element 54. The plural light-guiding structures 535 are aligned with corresponding key structures 51. When the light beam is projected on the plural light-guiding structures 535, a portion of the light beam is scattered to the plural key structures 51 by the plural light-guiding structures 535.

In this embodiment, the plural light-guiding structures 535 are produced by printing light-guiding ink on the bottom surface or the top surface of the lower wiring plate 532. The method of forming the plural light-guiding structures 535 on the bottom surface or the top surface of the lower wiring plate 532 is not restricted as long as the a portion of the light beam can be scattered to the plural key structures 51 by the plural light-guiding structures 535.

In accordance with a feature of the present invention, the illuminated keyboard 5 further comprises plural light-converging microstructures 536. The plural light-converging microstructures 536 are disposed over and aligned with the plural light-guiding structures 535, respectively. The portion of the light beam that is scattered to the plural key structures 51 by the plural light-guiding structures 535 is then transmitted through the plural light-converging microstructures 536 corresponding to the plural light-guiding structures 535. By the plural light-converging microstructures 536, the portion of the light beam that is scattered to the plural key structures 51 is converged, so that the deviated light beam can be directed to plural keycaps 511 of the plural key structures 51. Consequently, the plural keycaps 511 of the plural key structures 51 will exhibit high luminous efficacy.

Please refer to FIGS. 13 and 14 again. In this embodiment, the plural light-converging microstructures 536 may be formed on the bottom surface of the upper wiring plate 531 or the top surface of the upper wiring plate 531 and at the positions corresponding to the plural light-guiding structures 535. Moreover, the plural light-converging microstructures 536 may be produced by a laser engraving process or a chemical etching process or a hot pressing process. For example, the plural light-converging microstructures 536 include plural V-cut structures 5361 or plural U-cut structures 5362, but are not limited thereto.

The plural light-converging microstructures 536 as shown in FIGS. 13 and 14 are presented herein for purpose of illustration and description only, and are not intended to limit the shapes and distribution range of the plural light-converging microstructures 536. The plural light-converging microstructures 536 are not restricted as long as the portion of the light beam scattered to the plural key structures 51 by the plural light-guiding structures 535 can be converged and collected to be directed to the plural keycaps 511 of the plural key structures 51.

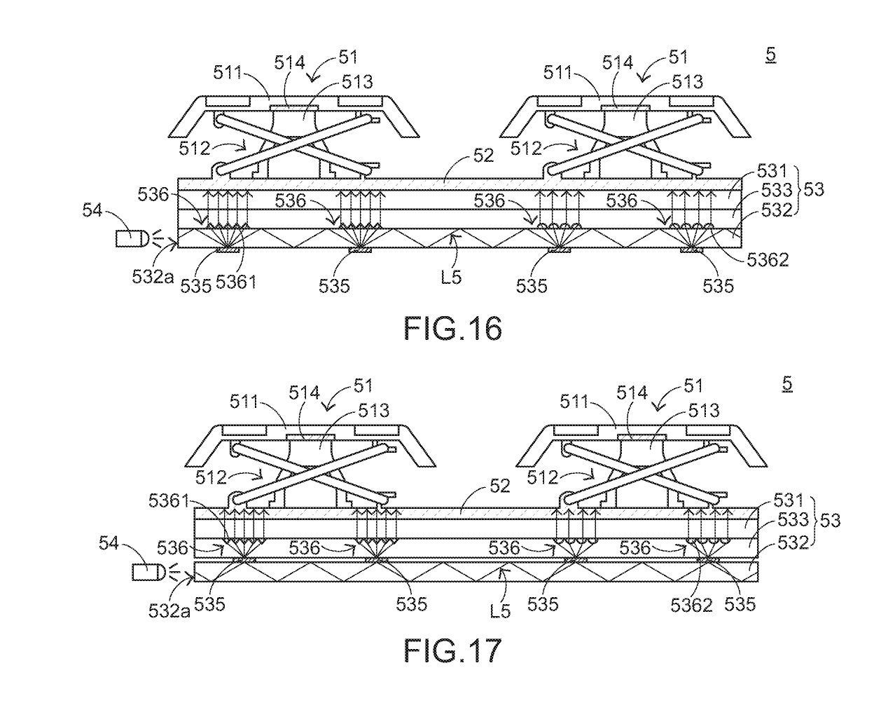

FIG. 16 is a schematic cross-sectional view illustrating another variant of the illuminated keyboard according to the fourth embodiment of the present invention. FIG. 17 is a schematic cross-sectional view illustrating a further variant of the illuminated keyboard according to the fourth embodiment of the present invention.

As shown in FIGS. 16 and 17, the plural light-converging microstructures 536 may be formed on a bottom surface of the intermediate plate 533 or a top surface of the intermediate plate 533 and at the positions corresponding to the plural light-guiding structures 535. Moreover, the plural light-converging microstructures 536 include plural V-cut structures 5361 or plural U-cut structures 5362, but are not limited thereto.

The plural light-converging microstructures 536 as shown in FIGS. 16 and 17 are presented herein for purpose of illustration and description only, and are not intended to limit the shapes and distribution range of the plural light-converging microstructures 536. The plural light-converging microstructures 537 are not restricted as long as the portion of the light beam scattered to the plural key structures 51 by the plural light-guiding structures 535 can be converged and collected to be directed to the plural keycaps 511 of the plural key structures 51.

Moreover, in this embodiment, both of the intermediate plate 533 and the upper wiring plate 531 are made of a light-transmissible material. Consequently, the portion of the light beam to be scattered to the plural key structures 51 by the plural light-guiding structures 535 can be transmitted through the intermediate plate 533 or the upper wiring plate 531 and directed to the plural key structures 51.

Please refer to FIGS. 13 and 14 again. The configurations of the plural key structures 51 and the supporting plate 52 of the illuminated keyboard 5 according to the fourth embodiment of the present invention will be illustrated in more details as follows.

The plural key structures 51 are disposed over the key wiring board 53. Each key structure 51 comprises a keycap 511, a scissors-type connecting element 512, and an elastic element 513. Moreover, each keycap 511 has plural light-outputting parts 511a. For example, the light-outputting parts 511a are located at the positions corresponding to character regions or symbol regions of the keycap 511. When the light beam is projected onto the keycap 511, the light beam can be outputted from the plural light-outputting parts 511a.

Moreover, the supporting plate 52 is arranged between the key wiring board 53 and the plural key structures 51 for fixing the scissors-type connecting element 512. The elastic element 513 is arranged between the keycap 511 and the supporting plate 52 for providing a restoring force to the keycap 511.

Moreover, the scissors-type connecting element 512 comprises a first frame 5121 and a second frame 5122. The first frame 5121 is pivotally coupled to the second frame 5122, and the first frame 5121 and the second frame 5122 intersect each other. A first end 5121a of the first frame 5121 and a first end 5122a of the second frame 5122 are connected to a first fixing structure 5111 and a second fixing structure 5112 of the keycap 511, respectively. A second end 5121b of the first frame 5121 and a second end 5122b of the second frame 5122 are connected to a third fixing structure 521 and a fourth fixing structure 522 of the supporting plate 52, respectively.

In case that the supporting plate 52 is made of a light-transmissible material, it is not necessary to form openings in the supporting plate 52 at the positions corresponding to the light-outputting parts 511a. Whereas, in case that the supporting plate 52 is made of an opaque material, the supporting plate 52 should have openings under the light-outputting parts 511a. Consequently, the light beam can be transmitted through the openings, and directed to the keycaps 511.

When the key wiring board 53 is electrically conducted, an electric field between each of the first electrode patterns 5311a and the corresponding second electrode pattern 5321a of the non-contact key switch 534 are generated. As any keycap 511 is depressed, the first frame 5121 and the second frame 5122 are rotated relative to each other. Consequently, the keycap 511 is moved downwardly. At the same time, the keycap 511 is moved downwardly to compress the elastic element 513, and thus the elastic element 513 is subjected to deformation. When the keycap 511 and the elastic element 512 are moved to a position near the non-contact key switch 534, the electric field generated by the non-contact key switch 534 is changed. Due to the change of the electric field, a controller (not shown) generates a corresponding non-contact key signal.

When the depressing force exerted on the keycap 511 is eliminated, the elastic element 513 is restored to its original shape. Consequently, the keycap 511 is moved upwardly and returned to the original position where the keycap 511 is not depressed. At the same time, the first frame 5121 and the second frame 5122 are rotated relative to each other again, and thus the first frame 5121 and the second frame 5122 are returned to their original positions.

For resulting in the change of the electric field of the non-contact key switch 534 corresponding to the depressed key structure 51, the key structure 51 further comprises a conductive structure 514 (see FIGS. 13 and 14). When the conductive structure 514 is moved to a position near the non-contact key switch 534, the electric field generated by the non-contact key switch 534 is changed. For example, the conductive structure 514 is metallic paint film coated on the key structure 51 or a conductive foam structure fixed on the key structure 51, but is not limited thereto.

It is noted that numerous modifications and alterations may be made while retaining the teachings of the invention. For example, the plural key structures 51 and the supporting plate 52 used in the illuminated keyboard 5 of this embodiment may be applied to the illuminated keyboard 3 of the second embodiment in order to replace the plural key structures 31 and the keycap guiding frame 32. Alternatively, the plural key structures 31 and the keycap guiding frame 32 used in the illuminated keyboard 3 of the second embodiment may be applied to the illuminated keyboard 5 of this embodiment in order to replace the plural key structures 51 and the supporting plate 52.

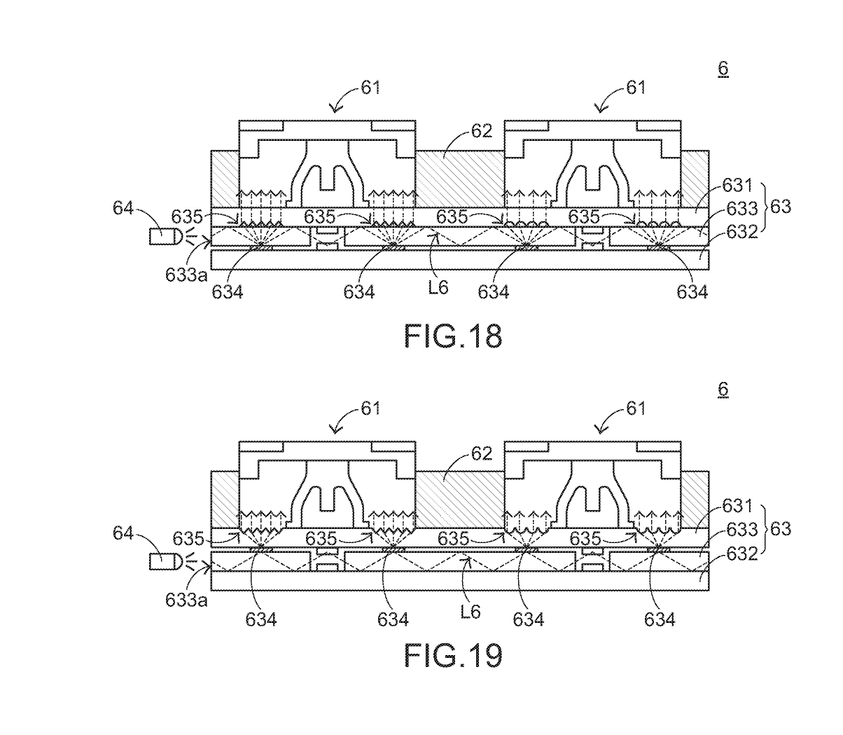

Hereinafter, the structures of an illuminated keyboard according to a fifth embodiment of the present invention will be illustrated with reference to FIGS. 18 and 19. FIG. 18 is a schematic cross-sectional view illustrating an illuminated keyboard according to a fifth embodiment of the present invention. FIG. 19 is a schematic cross-sectional view illustrating a variant of the illuminated keyboard according to the fifth embodiment of the present invention.

As shown in FIGS. 18 and 19, the illuminated keyboard 6 comprises plural key structures 61, a keycap guiding frame 62, and a key wiring board 63. Moreover, at least one light-emitting element 64 is located at a side of the key wiring board 63.

The structures of the key wiring board 63 will be illustrated in more details as follows. In this embodiment, the key wiring board 63 is a membrane switch wiring board.

The key wiring board 63 is disposed under the plural key structures 61. In this embodiment, the key wiring board 63 comprises an upper wiring plate 631, a lower wiring plate 632, and an intermediate plate 633.

In comparison with the third embodiment, the light-emitting element 64 is located at a lateral side 633a of the intermediate plate 633 for providing a light beam to the intermediate plate 633. After the light beam from the light-emitting element 64 is incident into the intermediate plate 633, the light beam is transferred within the intermediate plate 633 along an optical path L6. The optical path L6 is presented herein for purpose of illustration and description only, and is not intended to limit the optical path of the light beam of the present invention.

It is noted that the optical path passing through the region including the membrane switch of the key wiring board 63 is different from the optical path passing through the region excluding the membrane switch. In the cross-sectional views of FIGS. 18 and 19, the optical path L6 is the optical path passing through the region excluding the membrane switch. Consequently, the optical path L6 is indicated by dotted lines.

It is noted that the position of the light-emitting element 64 is not restricted. The light-emitting element 64 may be located at any lateral side of the intermediate plate 633. Alternatively, in some other embodiments, the illuminated keyboard 6 comprises two light-emitting elements 64, and the two light-emitting elements 64 are located at bilateral sides of the intermediate plate 633, respectively.

The intermediate plate 633 has low absorptivity and high refraction coefficient. Preferably, the intermediate plate 633 is made of a transparent light-guiding material. An example of the transparent light-guiding material includes but is not limited to polycarbonate (PC), polymethylmethacrylate (PMMA), polyethylene terephthalate (PET) or silicone.

Moreover, plural light-guiding structures 634 are formed on a bottom surface of the intermediate plate 633 (see FIG. 18) or the top surface of the intermediate plate 633 (see FIG. 19) for collecting and scattering the light beam, which is provided by the light-emitting element 64. The plural light-guiding structures 634 are aligned with corresponding key structures 61. When the light beam is projected on the plural light-guiding structures 634, a portion of the light beam is scattered to the plural key structures 61 by the plural light-guiding structures 634.

Moreover, the illuminated keyboard 6 further comprises plural light-converging microstructures 635. The plural light-converging microstructures 635 are disposed over and aligned with the plural light-guiding structures 634, respectively. The portion of the light beam that is scattered to the plural key structures 61 by the plural light-guiding structures 634 is then transmitted through the plural light-converging microstructures 635 corresponding to the plural light-guiding structures 634. By the plural light-converging microstructures 635, the portion of the light beam that is scattered to the plural key structures 61 is converged, so that the deviated light beam can be directed to plural keycaps 611 of the plural key structures 61. Consequently, the plural keycaps 611 of the plural key structures 61 will exhibit high luminous efficacy.

Please refer to FIGS. 18 and 19 again. In this embodiment, the plural light-converging microstructures 635 may be formed on the bottom surface of the upper wiring plate 631 or the top surface of the upper wiring plate 631 and at the positions corresponding to the plural light-guiding structures 634.

Moreover, in this embodiment, the upper wiring plate 631 is made of a light-transmissible material. Consequently, the portion of the light beam to be scattered to the plural key structures 61 by the plural light-guiding structures 634 can be transmitted through the upper wiring plate 631 and directed to the plural key structures 61.

The structures, materials and forming methods of other components of the key wiring board 63 of the illuminated keyboard 6 are similar to those of the key wiring board 43 of the illuminated keyboard 4 of third embodiment, and are not redundantly described herein.

Moreover, the structures, materials, assembling sequences and operating principles of the plural key structures 61 and the keycap guiding frame 62 are similar to those of the plural key structures 21 and the keycap guiding frame 22 of the first embodiment, and are not redundantly described herein. It is noted that numerous modifications and alterations may be made while retaining the teachings of the invention. For example, the plural key structures 41 and the supporting plate 42 used in the illuminated keyboard 4 of the third embodiment may be applied to the illuminated keyboard 6 of this embodiment in order to replace the plural key structures 61 and the keycap guiding frame 62.

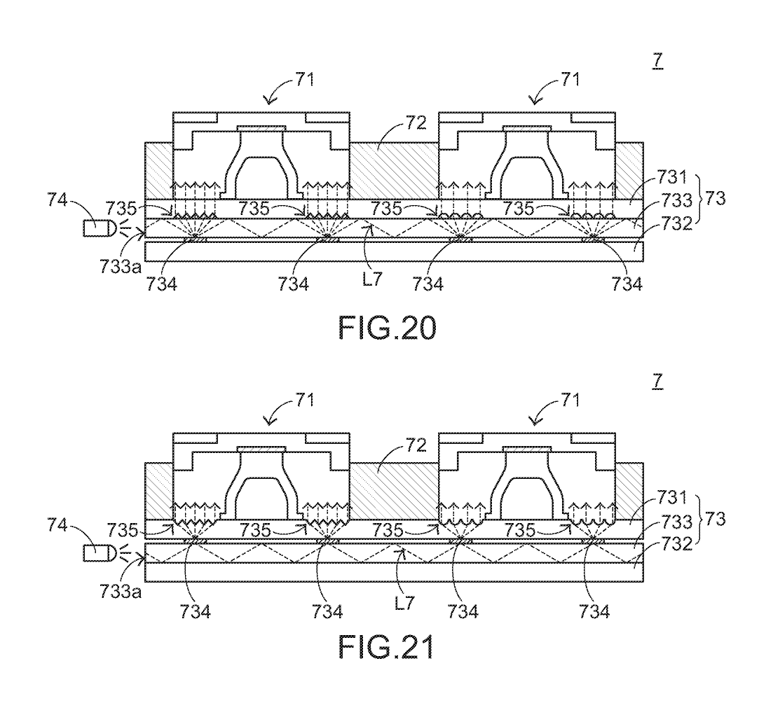

Hereinafter, the structures of an illuminated keyboard according to a sixth embodiment of the present invention will be illustrated with reference to FIGS. 20 and 21. FIG. 20 is a schematic cross-sectional view illustrating an illuminated keyboard according to a sixth embodiment of the present invention. FIG. 21 is a schematic cross-sectional view illustrating a variant of the illuminated keyboard according to the sixth embodiment of the present invention.

As shown in FIGS. 20 and 21, the illuminated keyboard 7 comprises plural key structures 71, a keycap guiding frame 72, and a key wiring board 73. Moreover, at least one light-emitting element 74 is located at a side of the key wiring board 73.

The structures of the key wiring board 73 will be illustrated in more details as follows. In this embodiment, the key wiring board 73 is a capacitive sensing wiring board.

In this embodiment, the key wiring board 73 comprises an upper wiring plate 731, a lower wiring plate 732, and an intermediate plate 733. The intermediate plate 733 is arranged between the upper wiring plate 731 and the lower wiring plate 732. In comparison with the fourth embodiment, the light-emitting element 74 is located at a lateral side 733a of the intermediate plate 733 for providing a light beam to the intermediate plate 733. After the light beam from the light-emitting element 74 is incident into the intermediate plate 733, the light beam is transferred within the intermediate plate 733 along an optical path L7. The optical path L7 is presented herein for purpose of illustration and description only, and is not intended to limit the optical path of the light beam of the present invention.

It is noted that the position of the light-emitting element 74 is not restricted. The light-emitting element 74 may be located at any lateral side of the intermediate plate 733. Alternatively, in some other embodiments, the illuminated keyboard 7 comprises two light-emitting elements 74, and the two light-emitting elements 74 are located at bilateral sides of the intermediate plate 733, respectively.

The intermediate plate 733 has low absorptivity and high refraction coefficient. Preferably, the intermediate plate 733 is made of a transparent light-guiding material. An example of the transparent light-guiding material includes but is not limited to polycarbonate (PC), polymethylmethacrylate (PMMA), polyethylene terephthalate (PET) or silicone.

Moreover, plural light-guiding structures 734 are formed on a bottom surface of the intermediate plate 733 (see FIG. 20) or the top surface of the intermediate plate 733 (see FIG. 21) for collecting and scattering the light beam, which is provided by the light-emitting element 74. The plural light-guiding structures 734 are aligned with corresponding key structures 71. When the light beam is projected on the plural light-guiding structures 734, a portion of the light beam is scattered to the plural key structures 71 by the plural light-guiding structures 734.

Moreover, the illuminated keyboard 7 further comprises plural light-converging microstructures 735. The plural light-converging microstructures 735 are disposed over and aligned with the plural light-guiding structures 734, respectively. The portion of the light beam that is scattered to the plural key structures 71 by the plural light-guiding structures 734 is then transmitted through the plural light-converging microstructures 735 corresponding to the plural light-guiding structures 734. By the plural light-converging microstructures 735, the portion of the light beam that is scattered to the plural key structures 71 is converged, so that the deviated light beam can be directed to plural keycaps 711 of the plural key structures 71. Consequently, the plural keycaps 711 of the plural key structures 71 will exhibit high luminous efficacy.

Please refer to FIGS. 20 and 21 again. In this embodiment, the plural light-converging microstructures 735 may be formed on the bottom surface of the upper wiring plate 731 or the top surface of the upper wiring plate 731 and at the positions corresponding to the plural light-guiding structures 734.

Moreover, in this embodiment, the upper wiring plate 731 is made of a light-transmissible material. Consequently, the portion of the light beam scattered to the plural key structures 71 by the plural light-guiding structures 734 can be transmitted through the upper wiring plate 731 and directed to the plural key structures 71.

The structures, materials and forming methods of other components of the key wiring board 73 of the illuminated keyboard 7 are similar to those of the key wiring board 53 of the illuminated keyboard 5 of fourth embodiment, and are not redundantly described herein.

Moreover, the structures, materials, assembling sequences and operating principles of the plural key structures 71 and the keycap guiding frame 72 are similar to those of the plural key structures 31 and the keycap guiding frame 32 of the second embodiment, and are not redundantly described herein. It is noted that numerous modifications and alterations may be made while retaining the teachings of the invention. For example, the plural key structures 51 and the supporting plate 52 used in the illuminated keyboard 5 of the fourth embodiment may be applied to the illuminated keyboard 7 of this embodiment in order to replace the plural key structures 71 and the keycap guiding frame 72.

From the above descriptions, the present invention provides an illuminated keyboard. In the illuminated keyboard, plural light-converging microstructures are disposed over corresponding light-guiding structures. The portion of the light beam that is scattered to the plural key structures by the plural light-guiding structures is then transmitted through the plural light-converging microstructures. By the plural light-converging microstructures, the portion of the light beam is converged and centralized to be directed to plural keycaps of the plural key structures. Consequently, the plural keycaps of the plural key structures will exhibit high luminous efficacy.

Moreover, the portion of the light beam that is scattered to the plural key structures by the plural light-guiding structures will not be deviated from the plural keycaps. Under this circumstance, the light beam can be effectively utilized. Consequently, the serious light leakage problem of leaking out the light beam through the region between every two adjacent keycaps will be overcome. More especially, since the brightness at the keycaps is increased, it is not necessary to employ the high-luminance light-emitting element or install more light-emitting elements. Under this circumstance, the fabricating cost of the illuminated keyboard is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An illuminated keyboard, comprising:
at least one light-emitting element for emitting at least one light beam;
a key wiring board for generating at least one key signal and transferring said at least one light beam, wherein said key wiring board comprises an upper wiring plate, a lower wiring plate and a spacer layer, wherein said upper wiring plate is made of a light-transmissible material, said lower wiring plate is made of a light-guiding material for transferring said at least one light beam, and said spacer layer is arranged between said upper wiring plate and said lower wiring plate;
at least one key structure disposed over said key wiring board, wherein when said at least one key structure is depressed, said key wiring board is triggered to generate said at least one key signal;
at least one light-guiding structure formed on said lower wiring plate and aligned with said at least one key structure, wherein said at least one light beam from said at least one light-emitting element is guided by said at least one light-guiding structure so as to be scattered to said at least one key structure; and
at least one light-converging microstructure formed on said upper wiring plate and aligned with said at least one light-guiding structure, wherein after said at least one light beam to be scattered to said at least one key structure is converged by said at least one light-converging microstructure, said converged light beam is directed to at least one keycap of said at least one key structure.

2. The illuminated keyboard according to claim 1, wherein said spacer layer is a UV insulating ink layer, which is formed on a bottom surface of said upper wiring plate or a top surface of said lower wiring plate.

3. The illuminated keyboard according to claim 1, wherein said at least one light-converging microstructure is produced by a laser engraving process or a chemical etching process or a hot pressing process, wherein said at least one light-converging microstructure includes at least one V-cut structure or at least one U-cut structure, and said at least one light-guiding structure is made of light-guiding ink.

4. The illuminated keyboard according to claim 1, wherein said at least one light-emitting element is located at a lateral side of said lower wiring plate.

5. The illuminated keyboard according to claim 1, wherein said upper wiring plate has at least one upper contact, said lower wiring plate has at least one lower contact corresponding to said at least one upper contact, and said at least one upper contact and said at least one lower contact are collaboratively defined as a membrane switch, wherein said spacer layer is not arranged between said at least one upper contact and said at least one lower contact.

6. The illuminated keyboard according to claim 1, wherein said key wiring board further comprises:
a first electrode layer formed on a bottom surface of said upper wiring plate, and comprising plural first electrode patterns; and
a second electrode layer formed on a top surface of said lower wiring plate, and comprising plural second electrode patterns, wherein when said key wiring board is electrically conducted, an electric field between each of said first electrode patterns and said corresponding second electrode pattern is generated, wherein when said at least one key structure is moved to a position near said electric field, said electric field is changed, so that said at least one key signal is generated by said key wiring board.

7. The illuminated keyboard according to claim 6, further comprising at least one conductive structure, wherein said at least one conductive structure is disposed on said at least one key structure, and said at least one conductive structure is a metallic paint film or a conductive foam structure.

8. The illuminated keyboard according to claim 1, wherein said at least one keycap has at least one a light-outputting part, and said at least one key structure further comprises at least one elastic element, wherein said at least one elastic element is connected with said at least one keycap for providing a restoring force to said at least one keycap, wherein said illuminated keyboard further comprises at least one keycap guiding frame over said key wiring board for fixing said at least one keycap and guiding a movement of said at least one keycap, wherein said at least one keycap guiding frame comprises at least one hollow portion, and said at least one keycap is movable within said hollow portion.

9. The illuminated keyboard according to claim 1, wherein said at least one keycap has at least one a light-outputting part, and said at least one key structure further comprises at least one scissors-type connecting element, wherein said scissors-type connecting element is connected with said at least one keycap, so that said keycap is movable upwardly or downwardly relative to said key wiring board, wherein said illuminated keyboard further comprises a supporting plate under said scissors-type connecting element for fixing said scissors-type connecting element.

10. An illuminated keyboard, comprising:
at least one light-emitting element for emitting at least one light beam;
a key wiring board for generating at least one key signal and transferring said at least one light beam, wherein said key wiring board comprises an upper wiring plate, a lower wiring plate and an intermediate plate, wherein said lower wiring plate is made of a light-guiding material for transferring said at least one light beam, and said intermediate plate is arranged between said upper wiring plate and said lower wiring plate for separating said upper wiring plate from said lower wiring plate;
at least one key structure disposed over said key wiring board, wherein when said at least one key structure is depressed, said key wiring board is triggered to generate said at least one key signal;
at least one light-guiding structure formed on said lower wiring plate and aligned with said at least one key structure, wherein said at least one light beam from said at least one light-emitting element is guided by said at least one light-guiding structure so as to be scattered to said at least one key structure; and
at least one light-converging microstructure formed on said upper wiring plate or said intermediate plate and aligned with said at least one light-guiding structure, wherein after said at least one light beam to be scattered to said at least one key structure is converged by said at least one light-converging microstructure, said converged light beam is directed to at least one keycap of said at least one key structure.

11. The illuminated keyboard according to claim 10, wherein said at least one light-emitting element is located at a lateral side of said lower wiring plate.

12. The illuminated keyboard according to claim 10, wherein said upper wiring plate has at least one upper contact, said intermediate plate has at least one perforation corresponding to said at least one upper contact, and said lower wiring plate has at least one lower contact corresponding to said at least one upper contact, wherein when said key wiring board is depressed, said at least one upper contact is inserted into said at least one perforation, wherein said at least one upper contact and said at least one lower contact are collaboratively defined as a membrane switch.

13. The illuminated keyboard according to claim 10, wherein said key wiring board further comprises:
a first electrode layer formed on a bottom surface of said upper wiring plate, and comprising plural first electrode patterns; and
a second electrode layer formed on a top surface of said lower wiring plate, and comprising plural second electrode patterns, wherein when said key wiring board is electrically conducted, an electric field between each of said first electrode patterns and said corresponding second electrode pattern is generated, wherein when said at least one key structure is moved to a position near said electric field, said electric field is changed, so that said at least one key signal is generated by said key wiring board.

14. The illuminated keyboard according to claim 13, further comprising at least one conductive structure, wherein said at least one conductive structure is disposed on said at least one key structure, and said at least one conductive structure is a metallic paint film or a conductive foam structure.

15. An illuminated keyboard, comprising:
at least one light-emitting element for emitting at least one light beam;
a key wiring board for generating at least one key signal and transferring said at least one light beam, wherein said key wiring board comprises an upper wiring plate, a lower wiring plate, and an intermediate plate, wherein said upper wiring plate is made of a light-transmissible material, said intermediate plate is made of a light-guiding material for transferring said at least one light beam, and said intermediate plate is arranged between said upper wiring plate and said lower wiring plate for separating said upper wiring plate from said lower wiring plate;
at least one key structure disposed over said key wiring board, wherein when said at least one key structure is depressed, said key wiring board is triggered to generate said at least one key signal;
at least one light-guiding structure formed on said intermediate plate and aligned with said at least one key structure, wherein said at least one light beam from said at least one light-emitting element is guided by said at least one light-guiding structure so as to be scattered to said at least one key structure; and
at least one light-converging microstructure formed on said upper wiring plate and aligned with said at least one light-guiding structure, wherein after said at least one light beam to be scattered to said at least one key structure is converged by said at least one light-converging microstructure, said converged light beam is directed to at least one keycap of said at least one key structure.

16. The illuminated keyboard according to claim 15, wherein said at least one light-emitting element is located at a lateral side of said intermediate plate.

17. The illuminated keyboard according to claim 15, wherein said upper wiring plate has at least one upper contact, said intermediate plate has at least one perforation corresponding to said at least one upper contact, and said lower wiring plate has at least one lower contact corresponding to said at least one upper contact, wherein when said key wiring board is depressed, said at least one upper contact is inserted into said at least one perforation, wherein said at least one upper contact and said at least one lower contact are collaboratively defined as a membrane switch.

18. The illuminated keyboard according to claim 15, wherein said key wiring board further comprises:
a first electrode layer formed on a bottom surface of said upper wiring plate, and comprising plural first electrode patterns; and
a second electrode layer formed on a top surface of said lower wiring plate, and comprising plural second electrode patterns, wherein when said key wiring board is electrically conducted, an electric field between each of said first electrode patterns and said corresponding second electrode pattern is generated, wherein when said at least one key structure is moved to a position near said electric field, said electric field is changed, so that said at least one key signal is generated by said key wiring board.

19. The illuminated keyboard according to claim 18, further comprising at least one conductive structure, wherein said at least one conductive structure is disposed on said at least one key structure, and said at least one conductive structure is a metallic paint film or a conductive foam structure.
